(19) United States
(12) Patent Application Publication
(10) Pub. No.: US 2012/0252414 A1
(43) Pub. Date: Oct. 4, 2012

(54) NETWORK DEVICE, SERVER DEVICE, INFORMATION PROCESSING DEVICE, AND AUTHENTICATION METHOD

(75) Inventor: Takashi ISHIDOSHIRO, Nagoya-shi (JP)

(73) Assignee: Buffalo Inc., Nagoya-shi (JP)

(21) Appl. No.: 13/435,643

(22) Filed: Mar. 30, 2012

(30) Foreign Application Priority Data
Mar. 30, 2011 (JP) 2011-074899

(51) Int. Cl. H04W 12/06

(52) U.S. Cl. 455/411

(57) ABSTRACT

A network device including an interface that communicates with a mobile phone terminal, and a controller that converts a password into a tone including a sound of at least one frequency, and controls the interface to transmit the tone to the mobile phone terminal. The mobile phone outputs the tone to an information processing device, which decodes the tone and uses the decoded tone for authentication at the network device.

### CROSS REFERENCE TO RELATED APPLICATION

The present application claims priority to Japanese Patent Application No. 2011-074899 filed on Mar. 30, 2011, the disclosure of which is hereby incorporated by reference in its entirety.

### BACKGROUND

1. Field of the Disclosure

The present disclosure relates to a network device, a server device, an information processing device and an authentication method that are used for an authentication process for a user of the information processing device.

2. Description of the Related Art

An information system authenticates a user using, for instance, a password so as to prevent unauthorized access. However, in such an authentication technique using a password, unauthorized access may be allowed if the password is stolen and used. A user who has forgotten the password cannot access the information system unless another password is redistributed.

In view of such a problem, there has been proposed a system in which a user acquires a password for logging into an information system to which the user is to log in (login target server) using a mobile phone terminal (Japanese Patent Laid-Open No. 2010-44654).

In a system described in Japanese Patent Laid-Open No. 2010-44654, a login target server originates a call to a mobile phone terminal of a user, and notifies the user of a password in a voice. The user listens to the password delivered by the voice via the mobile phone terminal, and inputs the password into an information processing device. The information processing device requests a login to the login target server using the password input by the user.

However, the system described in Japanese Patent Laid-Open No. 2010-44654 has the following problem.

This system requires the user to temporarily memorize the password delivered by the voice. Accordingly, the password transmitted by this system should be limited to a length that a general user can correctly memorize. That is, it is difficult to extend the password to improve security performance.

The problem of the password length may be solved when the user writes the password delivered by the voice on a piece of paper. In this case, however, the writing is annoying and inconvenient for the user. Further, there is a problem of causing unauthorized use of the password by a furtive glance at the piece of paper on which the password is written.

The present disclosure has been made in view of such situations. It is an object of the present disclosure to provide a network device, a server device, an information processing device and an authentication method that can maintain convenience while improving security performance.

### SUMMARY

The present disclosure converts a password into tones including at least a sound with one frequency by means of a predetermined conversion method, and transmits the tones to a mobile phone terminal of a user. The password is used for an authentication process in the network device.

### BRIEF DESCRIPTION OF THE DRAWINGS

FIG. 1 is a block diagram showing an overall configuration of an information system according to a first aspect of an embodiment;

FIG. 2 is a block diagram showing a configuration of a NAS according to the embodiment;

FIG. 3 is a block diagram showing a configuration of a mobile phone terminal according to the embodiment;

FIG. 4 is a block diagram showing a configuration of a PC according to the embodiment;

FIG. 5 is a sequence diagram for illustrating an authentication method according to the first aspect of the embodiment;

FIG. 6 is a block diagram showing an overall configuration of an information system according to a second aspect of the embodiment;

FIG. 7 is a block diagram showing a configuration of an authentication server according to the second aspect of the embodiment;

FIG. 8 is a sequence diagram for illustrating an authentication method according to the second aspect of the embodiment; and

FIG. 9 is a sequence diagram for illustrating an authentication method according to a third aspect of the embodiment.

### DETAILED DESCRIPTION OF EMBODIMENTS

Embodiments of the present disclosure will be described with reference to the drawings. In the drawings for the following embodiments, like or similar characters are assigned to elements performing similar operations.

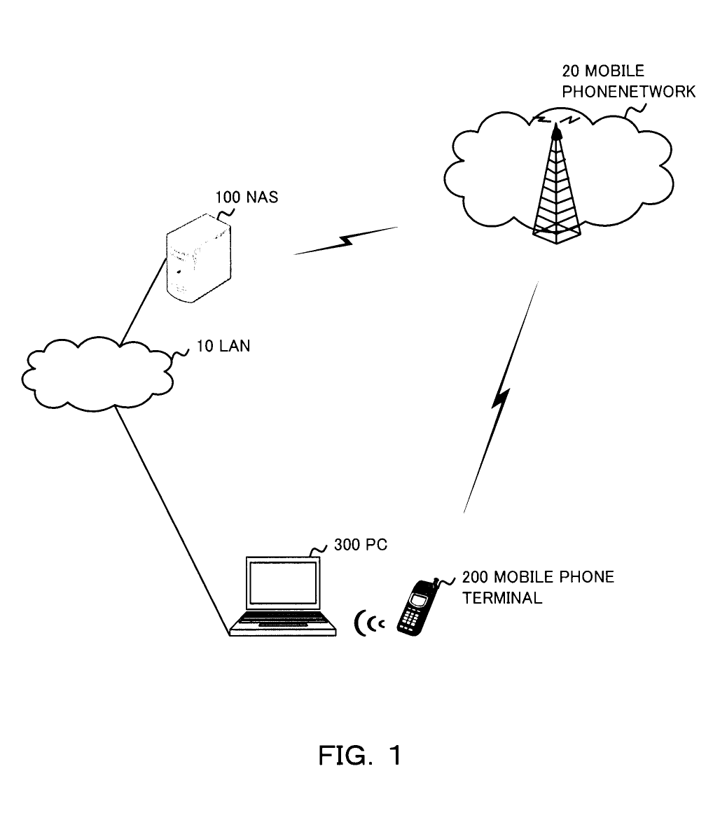

FIG. 1 is a block diagram showing an overall configuration of an information system according to a first aspect of an embodiment of the present disclosure. As shown in FIG. 1, the information system according to the first aspect of this embodiment includes a network attached storage device (NAS) 100, a mobile phone terminal 200, and a personal computer (PC) 300. Here, the NAS 100 operates as a network device to be a login target by a user. The NAS 100 and the PC 300 are connected to a network 10, such as a local area network (LAN) or a wide area network (WAN). The NAS 100 is wirelessly connected to a mobile phone network 20.

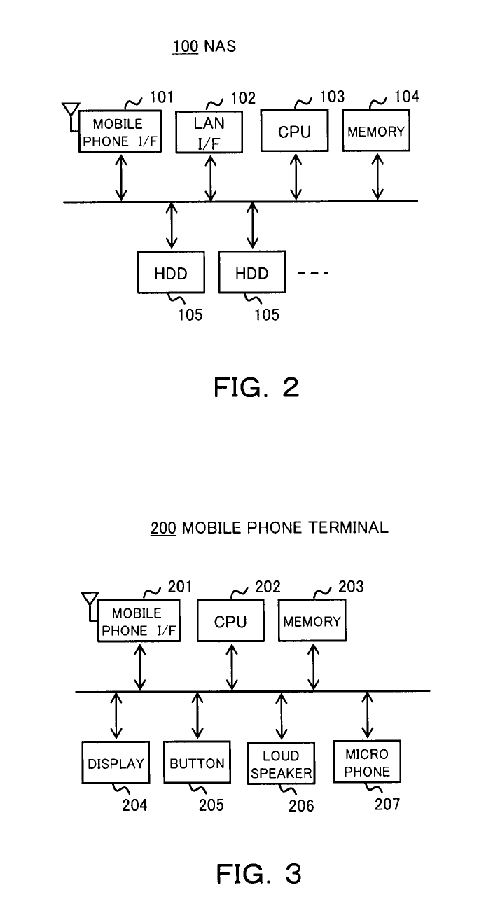

FIG. 2 is a block diagram showing a configuration of the NAS 100. As shown in FIG. 2, the NAS 100 includes a mobile phone interface (I/F) 101, a network interface 102, a central processing unit (controller) 103, a memory 104, and a plurality of hard disk drives (HDDs) 105.

The mobile phone I/F 101 communicates with the mobile phone terminal 200 or the like via the mobile phone network 20. More specifically, when the mobile phone I/F 101 receives an incoming call from the mobile phone terminal 200 via the mobile phone network 20, the mobile phone I/F 101 outputs information on an originating phone number received via a control channel to the controller 103. The mobile phone I/F 101 responds to the incoming call according to an instruction input from the controller 103 to thereby connect the call with the mobile phone terminal 200. The mobile phone I/F transmits a voice signal (after-mentioned tones) instructed by the controller 103, via a voice channel of the connected call.

The network interface 102 is a network card or the like, and connected to the network 10. The network interface 102 receives, as an input from the controller 103, information to be transmitted and the destination, and sends the information to be transmitted to the designated destination. The network interface 102 outputs information received via the network 10 to the controller 103.

The controller 103 is a program-controlled device, such as a CPU, and operates according to a program stored in the memory 104. When the controller 103 receives a login request via the network 10, the controller 103 transmits information indicating that a user name and a password are to be input, to the login requestor; this process is made as a basic process of the NAS. When the controller 103 receives the user name and the password via the network, the controller 103 determines whether or not the received user name and password are stored in the memory 104 in association with each other. Here, if the received user name and password are stored in the memory 104 in association with each other, the controller thereafter stores information in the HDD 105 or sends the information stored in the HDD 105 to the authentication user side according to an instruction from the originator of the received user name and password (authentication user side).

The authentication user side is, for instance, the PC 300. This login to the NAS 100 allows the PC 300 to read from and write into the NAS 100.

The controller 103 also performs following processes. On an incoming call to the mobile phone I/F 101 from the mobile phone terminal 200, the controller 103 receives, as an input, information on the originating phone number from the mobile phone I/F 101. The controller 103 reads the password stored in the memory 104 in association with the received originating phone number. Further, the controller 103 converts the read password into tones that include at least a sound with one frequency and can electronically be decoded. In a certain example in this embodiment, the tones are acquired by dual-tone multi-frequency (DTMF) conversion. Here, the DTMF conversion converts sixteen types of characters including numerals of 0 to 9 and characters of *, #, A, B, C and D into sixteen tones acquired by synthesizing two sounds with intervals different from each other, on the basis of standards prescribed in ITU-T Recommendation Q.23. However, the following aspect is not specifically limited to DTMF.

The memory 104 stores a program to be executed by the controller 103. The program may be stored and provided in a computer-readable recording medium and copied to the memory. The program may be received via a network and stored in the memory 104. Further, the memory 104 is used as a working space for the controller 103. In this embodiment, the memory 104 stores the user name, the phone number (a number delivered as an originating phone number) of the mobile phone terminal 200 of the user, and the password to be delivered to the user side in association with one another. The HDDs 105 store various types of information. In a certain example of this embodiment, the HDDs 105 may be configured as a RAID.

Next, an operation of the controller 103 will be described. After the mobile phone I/F 101 establishes a call with the mobile phone terminal 200, the controller 103 of the NAS 100 of this embodiment converts the password (the password associated with the phone number of the mobile phone terminal 200), which is to be provided for the user of the mobile phone terminal 200, into tones using DTMF conversion or the like. The controller 103 outputs the tones to the mobile phone I/F 101 and controls the I/F to transmit the tones to the mobile phone terminal 200. The mobile phone I/F 101 of this embodiment corresponds to a communication unit.

When the mobile phone I/F 101 receives an incoming call and the controller 103 receives, as an input, information on the originating phone number from the mobile phone I/F 101, the controller 103 may instruct the mobile phone I/F to terminate the call if the originating phone number is not stored in the memory 104. Here, the configuration is adopted where passwords are retained in association with respective phone numbers and the retained password is selectively read according to the received opposite party's number. However, in a case of only one user or a case of using the identical password to any user, for instance, the retained password is not necessarily associated with the phone number. Instead, it is sufficient only to retain the password in the memory 104. In this case, the controller 103 reads the password stored in the memory 104, converts the password into tones, and causes the tones to be transmitted via a voice channel.

FIG. 3 is a block diagram showing a configuration of the mobile phone terminal 200. As shown in FIG. 3, the mobile phone terminal 200 includes a mobile phone I/F 201, a controller 202, a memory 203, a display 204, an operation unit 205, a loudspeaker 206, and a microphone 207. The mobile phone may adopt any system capable of originating number notification and voice communication.

The mobile phone I/F 201 as a communication unit originates a call to an instructed opposite party, via a control channel of the mobile phone network 20, according to an instruction of originating the call, the instruction having been input from the controller 202. After the opposite party receives the call, the mobile phone I/F 201 starts communication with the opposite party via a voice channel. When the mobile phone I/F 201 accepts the call-in via the control channel of the mobile phone network 20, the I/F notifies the controller 202. When the controller 202 issues an instruction to respond during call-in, the mobile phone I/F 201 establishes communication with the originator of the call via the voice channel of the mobile phone network 20.

The controller 202 controls components of the mobile phone terminal 200 by executing a program stored in the memory 203. The controller 202 of this embodiment executes controls, such as originating and accepting a call, according to a user's instruction input from the operation unit 205. For instance, when the user inputs and calls the phone number for the destination, the controller instructs the mobile phone I/F 201 to call at the input phone number for the destination. On this occasion, the controller 202 issues an instruction of transmitting the phone number (the phone number at which the mobile phone I/F 201 accepts an incoming call) assigned to the mobile phone I/F 201 as the originating phone number to the destination. When the controller 202 receives from the mobile phone I/F 201 a notification indicating that the incoming call has accepted, the controller causes the loudspeaker 206 to sound a predetermined ringtone. If the user inputs an instruction to respond, the controller 202 outputs the instruction to respond to the mobile phone I/F 201.

When the mobile phone I/F 201 starts communication with the opposite party via the voice channel, the controller 202 outputs a voice signal received via the voice channel to the loudspeaker 206 to thereby sound the voice corresponding to the signal. The controller 202 outputs the voice signal output from the microphone 207 to the mobile phone I/F 201 to thereby instruct the I/F to transmit the signal to the opposite party via the voice channel.

The memory 203 stores a program to be executed by the controller 202. The program may be stored and provided in a computer-readable recording medium and copied to the memory. The program may be received via the network and stored in the memory 203. Further, the memory 203 is used as a working area of the controller 202.

The display 204 displays various types of information according to an instruction by the controller 202. The button 205 accepts an input from the user, and outputs a signal corresponding to the input to the controller 202. The loudspeaker 206 outputs a voice according to an instruction input from the controller 202. The microphone 207 converts an ambient voice into an electric voice signal, and outputs the voice signal acquired by this conversion to the controller 202.

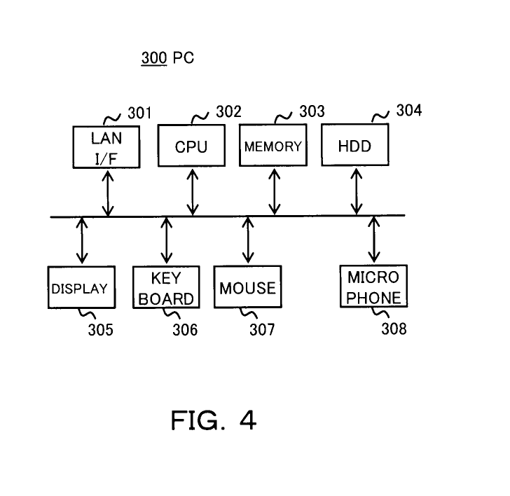

FIG. 4 is a block diagram showing a configuration of the PC 300 as an information processing device. As shown in FIG. 4, the PC 300 includes a network interface 301, a controller 302, a memory 303, a HDD 304, a display 305, a keyboard 306, a mouse 307 and a microphone 308. The information processing device is not limited to the PC 300 in this embodiment, but may be a video information reproduction device or the like. Here, description is made using an example of the PC 300.

The network interface 301 outputs information received via the network 10 to the controller 302. The network interface 301 sends information input from the controller 302, via the network 10.

The controller 302 controls components of the PC 300 by executing a program stored in the memory 303 or the HDD 304. More specifically, the controller 302 performs a process of decoding the tones in the voice information input from the microphone 308 according to an instruction by the user. For instance, in a case where the tone has been acquired by the DTMF conversion, the controller 302 applies DTMF decoding to the voice information input from the microphone 308. The method of executing DTMF decoding by using software is widely been known. Accordingly, the detailed description thereof is omitted. This embodiment is not limited thereto. Instead, the DTMF decoding may be executed using hardware, such as a CM8870 chip of California Micro Devices Corporation. In a case of execution by hardware, the controller 302 accepts an input of information after decoding that is output from the hardware. When information is acquired by decoding the tones, the controller 302 outputs the acquired information.

The memory 303 stores a program to be executed by the controller 302. The program may be stored and provided in a computer-readable recording medium and copied to the memory. The program may be received via the network and stored in the memory 303. Further, the memory 303 is used as a working area of the controller 302.

The HDD 304 stores various types of information. The display 305 displays information according to an instruction by the controller 302. The keyboard 306 and the mouse 307 accept an input from the user and output a signal corresponding to the input to the controller 302. The microphone 308 outputs a voice signal corresponding to an ambient voice to the controller 302. The microphone 308 may be embedded in a casing of the PC 300 or attached externally.

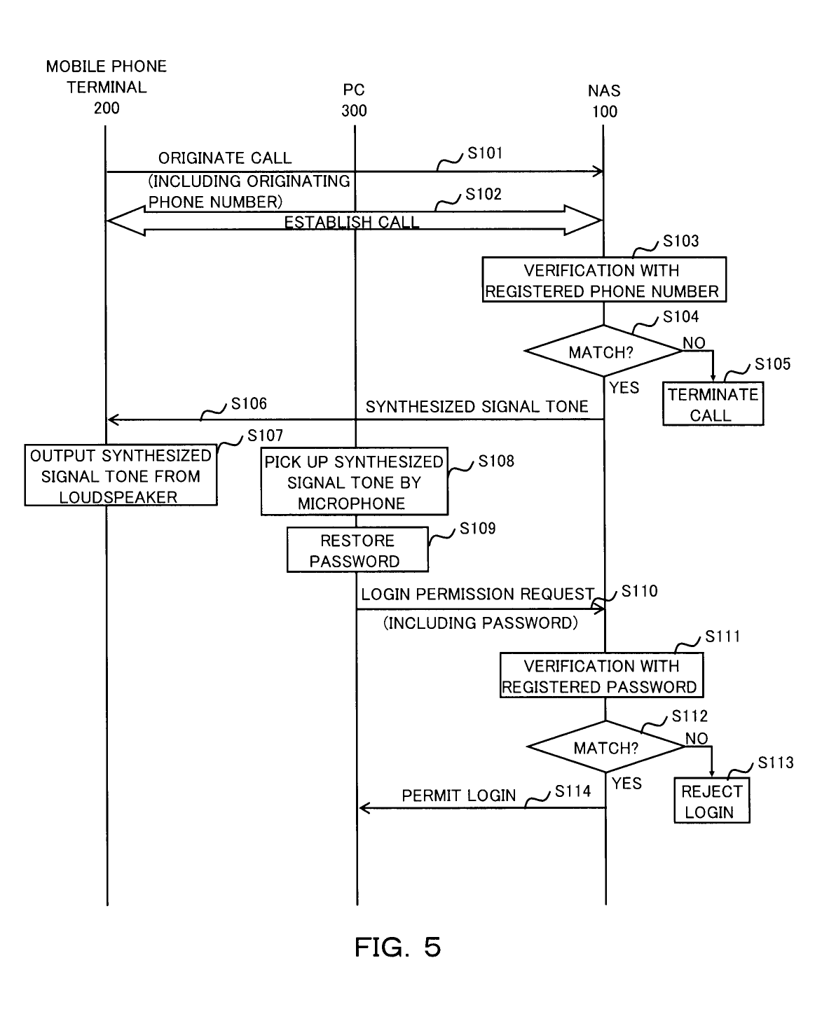

The first aspect of this embodiment includes the aforementioned configuration, and operates as follows. FIG. 5 is a sequence diagram for illustrating an authentication method according to the first aspect. The user operates the button 205 of the mobile phone terminal 200 to thereby input the phone number assigned to the mobile phone I/F 101 of the NAS 100 and operates to call the phone number (step S101).

The controller 202 of the mobile phone terminal 200 controls the mobile phone I/F 201 to transmit a call establishment request to the input phone number. At the origination of the call, the NAS 100 is notified of the phone number of the mobile phone terminal 200 as the originating phone number.

In step S102, the mobile phone I/F 101 of the NAS 100 accepts a call-in from the mobile phone terminal 200 via the mobile phone network 20. In step S103, the controller 103 of the NAS 100 accepts an input of the originating phone number, which is the phone number of the mobile phone terminal 200. The controller 103 determines whether or not one of the phone numbers stored in the memory 104 matches the input originating phone number.

If the originating phone number does not match any of the phone numbers stored in the memory 104 (step S104; NO), the controller 103 advances the processing to step S105 and rejects the incoming call. Instead, the call may be terminated after the call has been established once.

If the input originating phone number matches any of the phone numbers stored in the memory 104 in step S104 (step S104; YES), the controller 103 establishes a call and realizes a state capable of voice communication between the mobile phone terminal 200 and the NAS 100.

The controller 103 acquires the password stored in the memory 104, and converts the password into tones using DTMF conversion. In the case of storing the passwords in the memory 104 in association with the respective phone numbers, the controller 103 selectively reads the password associated with the phone number identical to the originating phone number. The controller 103 converts the read password into the tones using DTMF conversion, thus generating the tones corresponding to the password.

In step S106, the controller 103 of the NAS 100 controls the mobile phone I/F 101 to transmit the generated tones corresponding to the password to the mobile phone terminal 200 via the voice channel of the established call.

The mobile phone I/F 201 of the mobile phone terminal 200 receives the tones transmitted from the NAS 100 via the mobile phone network 20. The controller 103 of the NAS 100 may cause a voice that is stored in the memory 104 of the NAS 100 to be transmitted via the voice channel, indicating that the password is to be transmitted, before step S106 in which the tones are transmitted. This voice is an announcement voice, for instance, “Now the password is transmitted. Please turn up the volume of the mobile phone terminal and bring the terminal close to the PC”.

In step S107, the controller 202 of the mobile phone terminal 200 outputs the tones received by the mobile phone I/F 201 to the loudspeaker 206, thereby sounding the tones. By this stage, the user makes preparation such that the microphone 308 of the PC 300 can pick up a voice sounded by the loudspeaker 206 of the mobile phone terminal 200; this may be made by bringing the loudspeaker 206 of the mobile phone terminal 200 close to the microphone 308 of the PC 300.

In step S108, the microphone 308 of the PC 300 converts the tones sounded by the loudspeaker 206 of the mobile phone terminal 200 into an electric signal, and outputs the voice signal corresponding to the tones to the controller 302. In step S109, the controller 302 decodes the voice signal of the tones to thereby acquire the password.

The controller 302 controls the network interface 301 to transmit a login request to the NAS 100. When the NAS 100 responds to the login request and requests an input of the user name and the password, in step S110 the controller 302 sends the password acquired by decoding and the user name separately input by the user (login permission request).

The network interface 102 of the NAS 100 receives the login permission request including the decoded password.

In step S111, the controller 103 of the NAS 100 verifies whether or not the password included in the login permission request received by the network interface 102 matches the password stored in the memory 104.

If the password included in the login permission request does not match the password stored in the memory 104 (the password associated with the input user name) as the result of the verification (step S112; NO), in step S113 the controller 103 rejects the login and instructs the network interface 102 to notify the PC 300 of this rejection.

If the password included in the login permission request matches the password stored in the memory 104 (the password associated with the input user name) as the result of the verification in step S112 (step S112; YES), in step S114 the controller 103 permits the login and instructs the network interface 102 to notify the PC 300 of this permission.

After the login permission, the NAS 100 sends information stored in the HDD 105 to the PC 300 side according to an instruction input from the PC 300, which is the login permission requester. Alternatively, the NAS 100 stores information received from the PC 300 in the HDD 105 according to an instruction input from the PC 300.

According to this embodiment, the password is passed from the loudspeaker 206 of the mobile phone terminal 200 to the microphone 308 of the PC 300 by the tones, without intervention of the user, thereby enhancing the user's convenience and allowing the password length to be arbitrarily increased. On the basis of above examples, the password is limited to character types supporting the types of tones, such as sixteen characters capable of being subjected to the DTMF conversion/decoding. However, increase of the password length allows the security to be improved to a preferred extent. The loudspeaker 206 thus rings a sound related to the password. However, the sound is tones. Accordingly, if a third party catches the sound, it is difficult for this party to immediately grasp the content thereof. This can prevent unauthorized use of the password.

In this embodiment, in a case of adopting a scheme having a limitation of a convertible character type, such as DTMF, the password may be encoded into a combination of convertible character types, for instance, in representation of a hexadecimal string, such as the ASCII code and UNICODE (this encoding is referred to as a first step encoding for the sake of convenience), and subsequently converted into tones by DTMF conversion or the like (second step encoding). In this case, the information processing device side, such as the PC 300, generates the voice signal from the tones picked up by the microphone, and subsequently operates as follows. The PC 300 decodes the voice signal by performing a decoding method (second step decoding), such as DTMF decoding, corresponding to a method of conversion into tones (second step encoding). The PC 300 further decodes the information acquired by decoding by performing a method corresponding to the first step encoding (first step decoding), thereby acquiring the password.

More specifically, for instance, a password such as “Password” is represented as a character string, such as “50617373776F7264”, according to the ASCII code (hexadecimal) (after the first step encoding). Accordingly, the NAS 100 represents the character string after the first step encoding as tones by DTMF conversion (second step encoding) and transmits the tones. The PC 300 side applies the DTMF decoding to the tones received from the NAS 100, by DTMF decoding (second step decoding), thereby acquiring the character string of “50617373776F7264” having been generated after the first step encoding. The PC 300 further converts the character string into the original character string of the password, “Password”, with reference to the ASCII code table (first step decoding).

In the above description, the password has preliminarily been stored in the memory 104 or the like in the NAS 100. However, this embodiment is not limited thereto. For instance, the controller 103 may generate a random password by generating a random number, convert the generated random password into tones by DTMF conversion or the like, and transmit the tones.

In this case, the controller 103 retains the generated random password in the memory 104 at least temporarily. When the controller 103 receives the password from the PC 300 side, the controller 103 may determine whether or not the password matches the random password stored in the memory 104 and permit the login if the two passwords match.

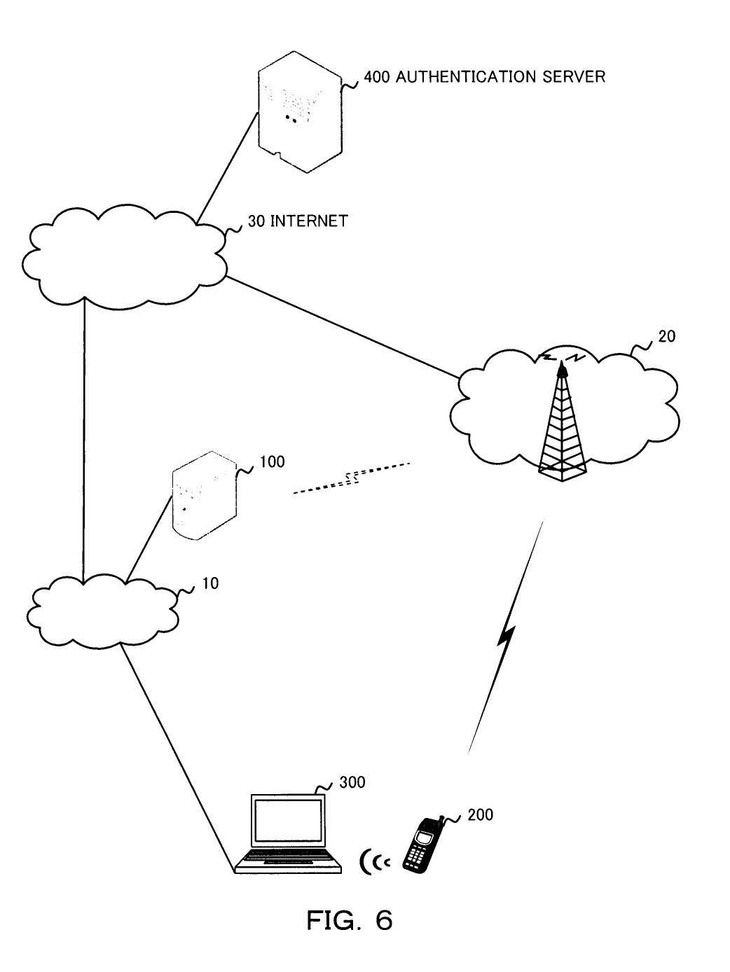

In another aspect of this embodiment (second aspect), an authentication server 400 executes authentication instead of the NAS 100. FIG. 6 is a block diagram showing an overall configuration of an information system according to the second aspect of this embodiment. As shown in FIG. 6, the information system according to the second aspect further includes the authentication server 400 capable of communication via Internet 30 or the like. The authentication server 400 may be operated and managed by, for instance, a manufacturer or the like providing the NAS 100.

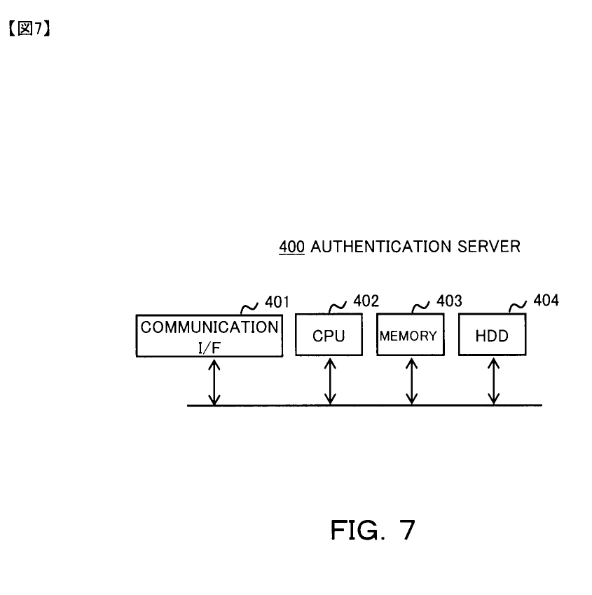

FIG. 7 is a block diagram showing an overall configuration of the authentication server 400 according to the second aspect. As shown in FIG. 7, the authentication server 400 includes a communication I/F 401, a controller 402, a memory 403 and a HDD 404.

The communication I/F 401 transmits and receives information via the Internet 30. The controller 402 controls components of the authentication server 400 by executing a program stored in the memory 403 or the HDD 404. More specifically, the controller 402 receives an authentication request of a phone number from the NAS 100. The authentication request includes information on an originating phone number. The controller 402 determines whether or not the originating phone number included in the authentication request matches the set number. The controller 402 returns the determination result to the NAS 100 having transmitted the authentication request.

The memory 403 stores a program to be executed by the controller 402. The program may be stored and provided in a computer-readable recording medium and copied to the memory. The program may be received via the network and stored in the memory 403. Further, the memory 403 is used as a working area of the controller 402. The HDD 404 stores various types of information. In the second aspect, at least one of the memory 403 and the HDD 404 has preliminarily stored a list of phone numbers of the mobile phone terminals 200 held by authenticated users.

Note that, in the second aspect, each NAS 100 may store the list of the phone numbers of the mobile phone terminals 200 held by the corresponding authenticated users. In this case, for instance, at least one phone number of the mobile phone terminal 200 held by the authenticated user of the NAS 100 that is identified by identification information uniquely assigned to the device of the NAS 100 (which may be a MAC address or a network address assigned to the network interface 102 of the NAS 100) is stored in association with the identification information.

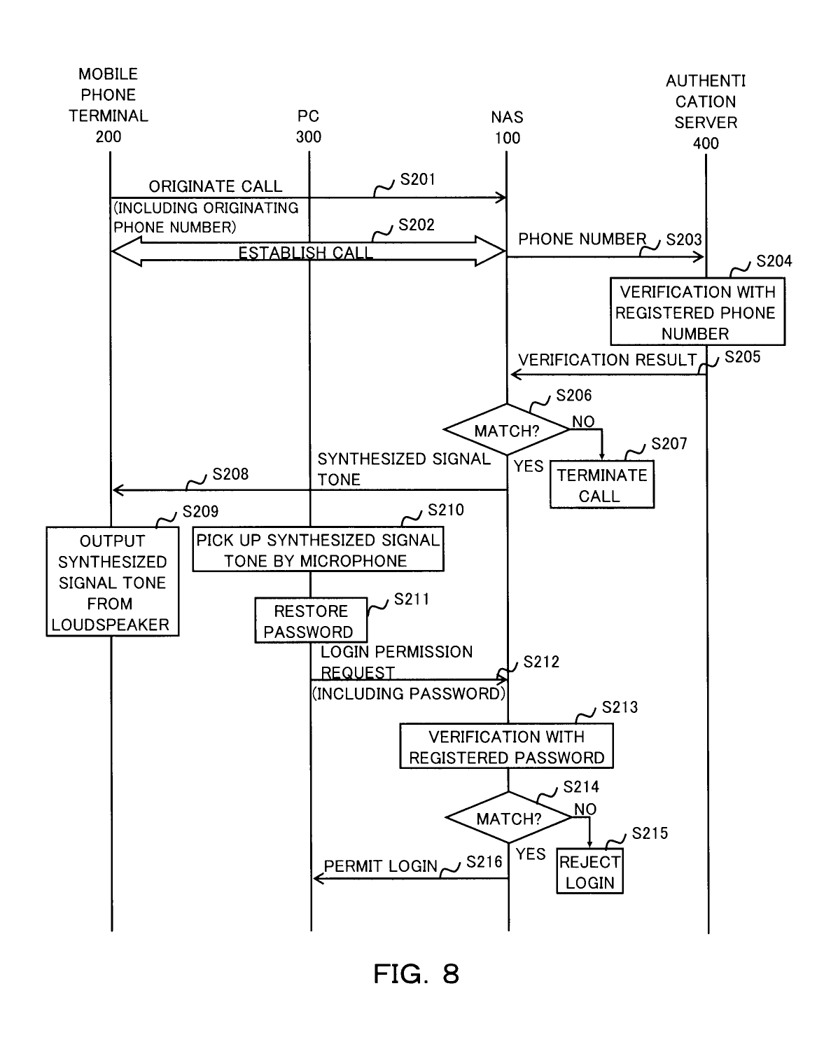

FIG. 8 is a sequence diagram for illustrating an authentication method according to the second aspect.

The user operates the button 205 of the mobile phone terminal 200 to thereby input the phone number assigned to the mobile phone I/F 101 of the NAS 100 and to perform an operation of originating a call (step S201).

The controller 202 of the mobile phone terminal 200 controls the mobile phone I/F 201 to transmit a call establishment request to the input phone number. At the origination of the call, the NAS 100 is notified of the phone number of the mobile phone terminal 200 as the originating phone number.

In step S202, the mobile phone I/F 101 of the NAS 100 accepts a call-in from the mobile phone terminal 200 via the mobile phone network 20. In step S203, the controller 103 of the NAS 100 accepts an input of the originating phone number, which is the phone number of the mobile phone terminal 200. The controller 103 instructs the network interface 102 to transmit the input originating phone number to the authentication server 400. The communication I/F 401 of the authentication server 400 receives the delivered originating phone number.

In step S204, the controller 402 of the authentication server 400 determines whether or not the originating phone number received by the communication I/F 401 is included in the list of the phone numbers having preliminarily been stored. Here, the authentication server 400 may receive the identification information uniquely assigned to the device from the NAS 100 side, and determine whether or not the originating phone number received by the communication I/F 401 is included in the phone number associated with the identification information.

In step S205, the controller 402 of the authentication server 400 instructs the communication I/F 401 to notify the NAS 100 of the determination result. The network interface 102 of the NAS 100 receives the determination result and outputs the result to the controller 103.

If the received determination result is negative, that is, the originating phone number transmitted to the authentication server 400 side is not stored (or the transmitted originating phone number is not stored in association with the identification information of the NAS 100) (step S206; NO), the controller 103 advances the processing to step S207 to rejects the incoming call. Instead, the call may be terminated after the call has been established once. The method of establishing the call once may be preferable in a case of requiring time for communication between the authentication server 400 and the NAS 100.

If the received determination result is positive in step S206, that is, the originating phone number transmitted to the authentication server 400 side is stored (or the transmitted originating phone number is stored in association with the identification information of the NAS 100 (step S206; YES), the controller 103 establishes the call to allow voice communication between the mobile phone terminal 200 and the NAS 100.

The controller 103 acquires the password stored in the memory 104, and converts the password into tones by DTMF conversion. In the case of storing the passwords in the memory 104 in association with the respective phone numbers, the controller 103 selectively reads the password associated with the phone number identical to the originating phone number. The controller 103 converts the read password by DTMF conversion into the tones, thus generating the tones corresponding to the password.

In step S208, the controller 103 of the NAS 100 controls the mobile phone I/F 101 to transmit the generated tones corresponding to the password to the mobile phone terminal 200 via the voice channel of the established call.

Processes thereafter are identical to those after transmission of the tones to the mobile phone terminal 200 in the first aspect. Accordingly, redundant description is omitted. Also in this case, the password is not necessarily a preliminarily stored password. Instead, the password may be a randomly generated password.

Thus, in the second aspect, the authentication server 400 manages the phone numbers of authenticated users in an integrated manner. Accordingly, it is not necessarily to register the phone number in the NAS 100.

The password may be transmitted by the authentication server 400 side which serves as a server device. Such a third aspect of this embodiment will hereinafter be described. An information system according to the third aspect is analogous to the information system according to the second aspect shown in FIG. 6, but different in that the password is transmitted by the authentication server 400 and the communication I/F 401 is capable of communication with the mobile phone terminal via the mobile phone network.

In the third aspect, the communication I/F 401 of the authentication server 400 communicates with the mobile phone terminal 200 or the like via the mobile phone network 20. More specifically, when the communication I/F 401 receives an incoming call from the mobile phone terminal 200 via the mobile phone network 20, the communication I/F 401 outputs information on an originating phone number received via a control channel to the controller 402. The communication I/F 401 responds to the incoming call according to an instruction input from the controller 402 to thereby connect the call with the mobile phone terminal 200. The communication I/F 401 transmits a voice signal (tones) instructed by the controller 402 via the voice channel of the connected call.

At least one of the memory 403 and the HDD 404 stores the user name, the phone number of the mobile phone terminal 200 of the user (the number delivered as the originating phone number), and the password to be delivered to the user side, in association with one another.

When the communication I/F 401 receives the incoming call, the controller 402 accepts an input of information on the originating phone number from the communication I/F 401. The controller 402 reads the password stored in the memory 403 or the like in association with the accepted originating phone number. Further, the controller 402 converts the read password into tones that includes at least a sound with one frequency and can electronically be decoded. In a certain example of this embodiment, the tones can be acquired by the DTMF conversion. However, the following aspect is not specifically limited to the DTMF.

When the communication I/F 401 receives an incoming call and the controller 402 accepts an input of information on the originating phone number from the communication I/F 401, if the originating phone number is not stored in the memory 403 or the like, the controller 402 of the authentication server 400 may instruct the communication I/F 401 to terminate the call. Here, the configuration is adopted where passwords are retained in association with respective phone numbers and the stored password is selectively read according to the received opposite party's number. However, in a case of only one user or a case of using the identical password to any user, the retained password is not necessarily associated with the phone number. Instead, it is sufficient only to retain the password in the memory 403 or the like. In this case, the controller 402 reads the password stored in the memory 403 or the like, converts the password into tones, and causes the tones to be transmitted via a voice channel.

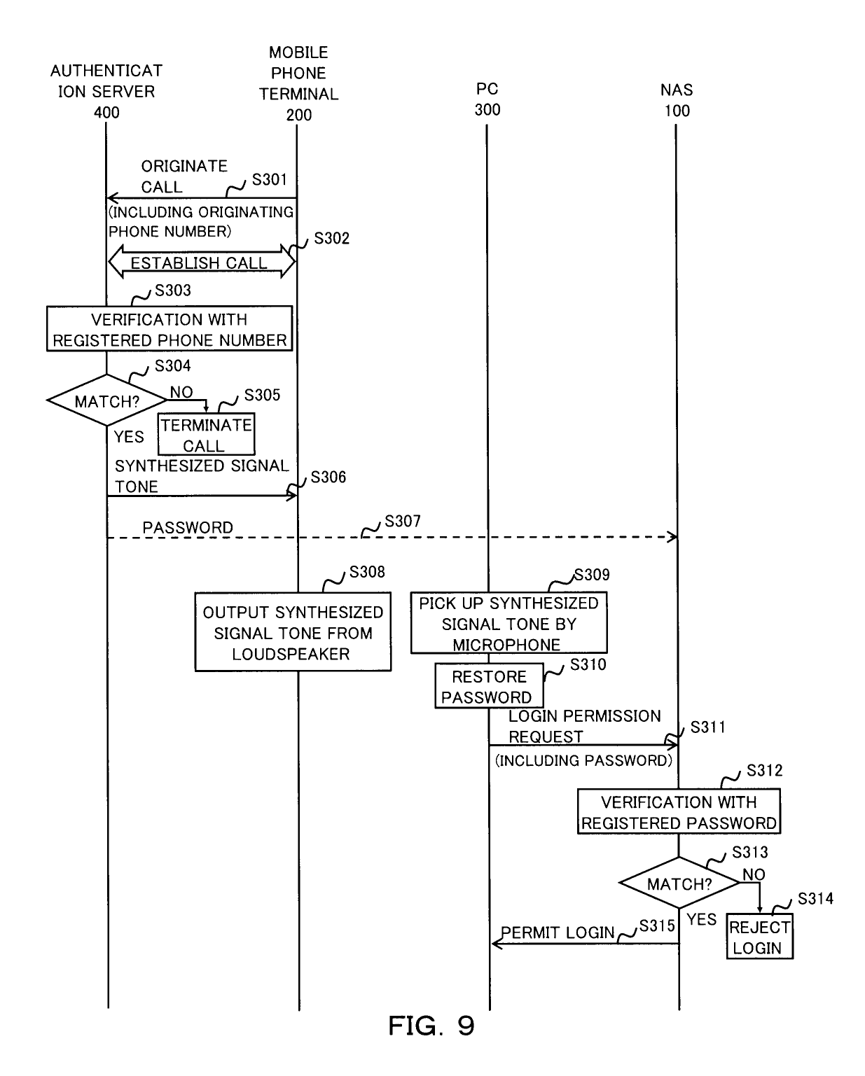

FIG. 9 is a sequence diagram for illustrating an authentication method according to the third aspect. As shown in FIG. 9, in step S301, the user operates the button 205 of the mobile phone terminal 200 to thereby input the phone number assigned to the communication I/F 401 of the authentication server 400 and to perform an operation of originating a call.

In step S302, the communication I/F 401 of the authentication server 400 accepts a call-in from the mobile phone terminal 200 via the mobile phone network 20. In step S303, the controller 402 of the authentication server 400 accepts an input of the originating phone number, which is the phone number of the mobile phone terminal 200. The controller 402 determines whether or not one of the phone numbers stored in the memory 403 or the like matches the input originating phone number.

If the originating phone number does not match any of the phone numbers stored in the memory 403 or the like (step S304; NO), the controller 402 advances the processing to step S305 and rejects the incoming call. Instead, the call may be terminated after the call has been established once.

On the other hand, if the input originating phone number matches any of the phone numbers stored in the memory 403 or the like in step S304 (step S304; YES), the controller 402 establishes a call and realizes a state capable of voice communication between the mobile phone terminal 200 and the NAS 100.

The controller 402 acquires the password stored in the memory 403 or the like, and converts the password into tones by DTMF conversion. In the case of storing the passwords in the memory 403 or the like in association with the respective phone numbers, the controller 402 selectively reads the password associated with the phone number identical to the originating phone number. The controller 402 converts the read password into the tones by DTMF conversion, thus generating the tones corresponding to the password.

In step S306, the controller 402 of the authentication server 400 controls the communication I/F 401 to transmit the generated tones corresponding to the password to the mobile phone terminal 200 via the voice channel of the established call. The controller 402 may cause a voice to be transmitted, indicating that the password preliminarily stored in the memory 403 or the like is to be transmitted, before a step of transmitting the tones. This voice is an announcement voice, for instance, “Now the password is transmitted. Please turn up the volume of the mobile phone terminal and bring the terminal close to the PC”.

The mobile phone I/F 201 of the mobile phone terminal 200 receives the tones transmitted from the authentication server 400, via the mobile phone network 20.

In step S307, the controller 402 of the authentication server 400 instructs the communication I/F 401 to transmit the password acquired from the memory 403 or the like (the password corresponding to the tones transmitted in step S306) to the NAS 100 via the network 10. The network interface 102 of the NAS 100 receives the transmitted password and stores the password in the memory 104. In the case where the NAS 100 has preliminarily stored the password, step S307 may be unnecessary.

Subsequently, the controller 202 of the mobile phone terminal 200 outputs the tones received by the mobile phone I/F 201 to the loudspeaker 206, thereby sounding the tones. By this stage, the user makes preparation such that the microphone 308 of the PC 300 can pick up a voice sounded by the loudspeaker 206 of the mobile phone terminal 200; this may be made by bringing the loudspeaker 206 of the mobile phone terminal 200 close to the microphone 308 of the PC 300.

The microphone 308 of the PC 300 converts the tones sounded by the loudspeaker 206 of the mobile phone terminal 200 into an electric signal, and outputs the voice signal corresponding to the tones to the controller 302. The controller 302 decodes the voice signal of the tones to thereby acquire the password.

Here, the controller 302 controls the network interface 301 to transmit a login request to the NAS 100. When the NAS 100 responds to the login request and requests an input of the user name and the password, the controller 302 sends the password acquired by decoding and the user name separately input by the user (login permission request).

The network interface 102 of the NAS 100 receives the login permission request including the decoded password. The controller 103 of the NAS 100 verifies whether or not the password included in the login permission request received by the network interface 102 matches the password stored in the memory 104. The password has been received from the authentication server 400 in step S307, or has been preset.

If the password included in the login permission request does not match the password stored in the memory 104 (the password associated with the input user name) as the result of the verification, the controller 103 rejects the login and instructs the network interface 102 to notify the PC 300 of this rejection.

If the password included in the login permission request matches the password stored in the memory 104 (the password associated with the input user name) as the result of the verification, the controller 103 permits the login and instructs the network interface 102 to notify the PC 300 of this permission.

After the login permission, the NAS 100 sends information stored in the HDD 105 to the PC 300 side according to an instruction input from the PC 300, which is the login permission requester. In addition thereto or instead thereof, the NAS 100 stores information received from the PC 300 in the HDD 105 according to an instruction input from the PC 300.

In the third aspect, the authentication server 400 transmits the password. This negates the need for the mobile phone I/F of the NAS 100.

In the third aspect, in a case where the controller 402 of the authentication server 400 adopts a scheme having a limitation of a convertible character type, such as the DTMF, as the method of conversion into tones, the password may be encoded into a combination of convertible character types, for instance, in representation of a hexadecimal string, such as the ASCII code and UNICODE (this encoding is referred to as a first step encoding for the sake of convenience), and subsequently, converted into tones by DTMF conversion or the like (second step encoding). In this case, the information processing device side, such as the PC 300, generates the voice signal from the tones picked up by the microphone, and subsequently operates as follows. The PC 300 decodes the voice signal by performing a decoding method (second step decoding) corresponding to a method of conversion into tones (second step encoding), such as the DTMF decoding. The PC 300 further decodes the information acquired by decoding (first step decoding) by performing a method corresponding to the first step encoding, thereby acquiring the password.

In the above description, the password is delivered from the authentication server 400 to the NAS 100, or has preliminarily been stored in the memory 104 or the like of the NAS 100. However, this embodiment is not limited thereto. For instance, the controller 402 of the authentication server 400 may generate a random password by generating random numbers, instead of picking up from the memory 403 or the like in step S307, convert the generated random password into tones by DTMF conversion or the like, and transmit the tones.

In this case, the controller 402 notifies the NAS 100 of the generated random password. The NAS 100 retains the password in the memory 104 at least temporarily. When the controller 103 receives the password from the PC 300 side, the controller 103 may determine whether or not the password matches the random password stored in the memory 104 and permit the login if they match with each other.

While the present disclosure is described in terms of preferred or exemplary embodiments, it is not limited hereto.

For instance, in the examples illustrated in the aforementioned aspects, the authentication process for login to the NAS 100 has been described. However, this embodiment is not limited thereto. That is, the present disclosure is applicable also to an authentication process for login to an arbitrary server. The present disclosure is not limited to the authentication process for login, but may be applied to an authentication process for decryption or the like.

In the aforementioned embodiments, the NAS 100 includes the mobile phone I/F 201 wirelessly connected to the mobile phone network 20. However, the NAS 100 may use a fixed phone I/F (a so-called modem) connected to a fixed phone network instead of the mobile phone I/F 201. It should thus be understood that the present disclosure includes various embodiments and the like.

Further, this embodiment has the following feature.

An authentication method for performing an authentication process for a user using a network device (NAS 100) via an information processing device (PC 300) to the network device, including: an establishment step Sin which a mobile phone terminal (mobile phone terminal 200) of the user establishes a call with the network device; a transmission step Sin which the network device converts a password to be used in the authentication process into a synthesized signal tone using a predetermined conversion scheme and transmits the synthesized signal tone to the mobile phone terminal; an output step Sin which the mobile phone terminal causes a loudspeaker (loudspeaker 206) to output the synthesized signal tone received from the network device; a sound pick-up step Sin which the information processing device causes a microphone (microphone 308) to pick up the synthesized signal tone output from the mobile phone terminal; a restoration step Sin which the information processing device converts the synthesized signal tone picked up by the microphone, by using the predetermined conversion scheme, to restore the password; and an authentication step S in which the information processing device uses the restored password for the authentication process.

Here, the password is directly input from the loudspeaker of the mobile phone terminal to the microphone of the information processing device. This allows the password length to be increased, thereby improving the security performance. The password is transmitted from the mobile phone terminal to the information processing device in a state of being converted into the synthesized signal tone. Accordingly, even if a third party catches the synthesized signal tone, it is substantially impossible to grasp the content. The user brings the mobile phone terminal close to the microphone of the information processing device, which enables the password to be input. This allows the user's convenience to be improved without increasing the user's efforts.

Another feature is an authentication method for performing an authentication process for a user using a network device (NAS 100) via an information processing device (PC 300) to the network device, including: an establishment step Sin which a mobile phone terminal (mobile phone terminal 200) of the user establishes a call with a server device (authentication server 400) capable of distributing a password to be used in the authentication process; a transmission step Sin which the server device converts the password to be used in the authentication process into a synthesized signal tone by using a predetermined conversion scheme and transmits the synthesized signal tone to the mobile phone terminal; an output step S in which the mobile phone terminal causes a loudspeaker (loudspeaker 206) to output the synthesized signal tone received from the server device; a sound pick-up step Sin which the information processing device causes a microphone (microphone 308) to pick up the synthesized signal tone output from the mobile phone terminal; a restoration step Sin which the information processing device converts the synthesized signal tone picked up by the microphone, by using the predetermined conversion scheme, to restore the password; and an authentication step S in which the information processing device uses the restored password for the authentication process.

Further, a network device is a network device (NAS 100) capable of distributing a password, including: a communication unit (mobile phone I/F 101) for communicating with a mobile phone terminal (mobile phone terminal 200); and a controller (controller 103) performing control of converting the password into a synthesized signal tone by using a predetermined conversion scheme after establishing a call with the mobile phone terminal, and transmitting the synthesized signal tone to the mobile phone terminal. The password may be used in an authentication process for a user using the network device via an information processing device (PC 300) to the network device.

A server device is a server device (authentication server 400) connected to the Internet (Internet 30) and capable of distributing a password, including: a communication unit (communication I/F 401) for communicating with a mobile phone terminal (mobile phone terminal 200); and a controller (controller 402) performing control of converting the password into a synthesized signal tone by using a predetermined conversion scheme after establishing a call with the mobile phone terminal, and transmitting the synthesized signal tone to the mobile phone terminal. The password may be used in an authentication process for a user using a network device (NAS 100) via an information processing device (PC 300) to the network device.

A mobile phone terminal is a mobile phone terminal (mobile phone terminal 200) including a loudspeaker (loudspeaker 206), further including: a communication unit (mobile phone I/F 201) for communicating with a network device (NAS 100) or a server device (authentication server 400) that is capable of distributing a password; and a controller (controller 202) controls the loudspeaker to, after a synthesized signal tone obtained by conversion of the password by using a predetermined conversion scheme is received by the communication unit, output the received synthesized signal tone. The password is used in an authentication process for a user using the network device via an information processing device (PC 300) to the network device.

An information processing device includes: a microphone (microphone 308); and a controller (controller 302) controls the microphone to pick up a synthesized signal tone output from a mobile phone terminal (mobile phone terminal 200) and subsequently converts the picked-up synthesized signal tone by using a predetermined conversion scheme, thereby restoring the password. The password is used in an authentication process for a user using a network device (NAS 100) via the information processing device to the network device.

What is claimed is:

1. A network device, comprising:
an interface that communicates with a mobile phone terminal; and
a controller that converts a password into a tone including a sound of at least one frequency, and controls the interface to transmit the tone to the mobile phone terminal.

2. The network device of claim 1, wherein the controller performs a dual-tone multi-frequency (DTMF) conversion on the password to covert the password into the tone.

3. The network device of claim 2, wherein the controller encodes the password into a DTMF-convertible character type before converting the password into the tone by performing the DTMF conversion.

4. The network device of claim 1, further comprising:
a memory that stores the password in association with a phone number corresponding to the mobile phone terminal.

5. The network device of claim 4, wherein the interface receives an incoming call from the mobile phone terminal and outputs the phone number corresponding to the mobile phone terminal to the controller in response to receiving the incoming call.

6. The network device of claim 5, wherein the controller receives the phone number output from the interface and retrieves the password associated with the phone number from the memory.

7. The network device of claim 1, wherein the password is a password for authentication at the network device.

8. A server device configured to communicate with a network device via a network, the server device comprising:
an interface that communicates with a mobile phone terminal; and
a controller that converts a password into a tone including a sound of at least one frequency, and control the interface to transmit the tone to the mobile phone terminal.

9. The server device of claim 8, wherein the controller performs a dual-tone multi-frequency (DTMF) conversion on the password to covert the password into the tone.

10. The server device of claim 9, wherein the controller encodes the password into a DTMF-convertible character type before converting the password into the tone by performing the DTMF conversion.

11. The server device of claim 8, further comprising:
a memory that stores the password in association with a phone number corresponding to the mobile phone terminal.

12. The server device of claim 11, wherein the interface receives an incoming call from the mobile phone terminal and outputs the phone number corresponding to the mobile phone terminal in response to receiving the incoming call.

13. The server device of claim 12, wherein the controller receives the phone number output from the interface and retrieves the password associated with the phone number from the memory.

14. The server device of claim 8, wherein the controller controls the interface to transmit the password to the network device.

15. The server device of claim 8, wherein the password is a password for authentication at the network device.

16. An information processing device, comprising:
a microphone;
a controller that decodes a tone including a sound of at least one frequency received at the microphone; and
an interface, wherein the controller controls the interface to transmit the decoded tone to a network device connected to the information processing device via a network for authentication at the network device.

17. A method of performing authentication at a network device, the method comprising:
initiating a call from a mobile phone terminal to the network device;
converting, by the network device, a password into a tone including a sound of at least one frequency;
transmitting the tone from the network device to the mobile phone terminal;
outputting, from a speaker of the mobile phone terminal, the tone received from the network device;
receiving, at a microphone of an information processing device, the tone output from the speaker of the mobile phone terminal;
decoding, by the information processing device, the tone received at the microphone to restore the password; and
transmitting the restored password from the from the information processing device to the network device to perform authentication at the network device.

18. A method of performing authentication at a network device, the method comprising:
initiating a call from a mobile phone terminal to a server connected to the network device via a network;
converting, by the server, a password for authentication at the network device into a tone including a sound of at least one frequency;
transmitting the tone from the server to the mobile phone;
outputting, from a speaker of the mobile phone terminal, the tone received from the network device;
receiving, at a microphone of an information processing device, the tone output from the speaker of the mobile phone terminal;
decoding, by the information processing device, the tone received at the microphone to restore the password; and
transmitting the restored password from the from the information processing device to the network device to perform authentication at the network device.
